(19) United States
(12) Patent Application Publication
(10) Pub. No.: US 2024/0289412 A1
(43) Pub. Date: Aug. 29, 2024

(54) METHOD AND DEVICE FOR SLIDING WINDOW CONSTRAINT OUTLIER-TOLERANT FILTERING NOISE REDUCTION OF PETROCHEMICAL INSTRUMENT SAMPLING DATA

(71) Applicant: Guangdong University of Petrochemical Technology, Maoming (CN)

(72) Inventors: Shaolin HU, Maoming (CN); Yidan XIN, Maoming (CN); Qinghua ZHANG, Maoming (CN); Chenglin WEN, Maoming (CN); Guoxi SUN, Maoming (CN); Mei LIU, Maoming (CN); Chunbin QIN, Maoming (CN); Ye KE, Maoming (CN)

(21) Appl. No.: 18/471,203

(22) Filed: Sep. 20, 2023

(30) Foreign Application Priority Data
Feb. 17, 2023 (CN) 202310125541.6

(51) Int. Cl. G06F 17/11

(52) U.S. Cl. CPC G06F 17/11

(57) ABSTRACT

Provided are a method and a device for sliding window constraint outlier-tolerant filtering noise reduction of petrochemical instrument sampling data. The method includes following steps: acquiring a petrochemical instrument sampling data sequence; obtaining a sliding window constraint function and a sliding window residual constraint function according to the petrochemical instrument sampling data sequence; and obtaining filtering and noise reduction results of instrument sampling data according to the sliding window constraint function and the sliding window residual constraint function.

### CROSS-REFERENCE TO RELATED APPLICATIONS

This disclosure claims priority to Chinese Patent Application No. 202310125541.6, filed on Feb. 17, 2023, the contents of which are hereby incorporated by reference.

### TECHNICAL FIELD

The disclosure belongs to the technical field of petrochemical instruments, and particularly relates to a method and a device for sliding window constraint outlier-tolerant filtering noise reduction of petrochemical instrument sampling data.

### BACKGROUND

In a process of petrochemical production, both working condition monitoring and product testing are inseparable from instrument sampling data, especially instrument sampling data such as temperature, pressure, flow and liquid level. For a convenience of description, it may be briefly recorded without loss of generality that sampling data of an instrument at anytime tᵢ is y(tᵢ), a sampling start time is t₀ and a sampling time interval is h=tᵢ−tᵢ₋₁. In an actual process of petrochemical production, the sampling data {y(tᵢ)|i=1, 2 . . . } of the instrument is usually a non-stationary time series with random errors. Because sampling measurement data not only contains random errors, but also is interfered by a recording process, environmental emergencies and accidental events of a data wireless transmission link, it is inevitable that error codes or errors may occur, so that the sampling data contains a small number of isolated outliers or local outlier speckles. How to avoid adverse effects of outliers/speckles, effectively weaken or eliminate effects of random errors, and obtain actual changes of instrument sampling objects as accurately as possible is a technical problem with a clear practical background, and it is also a technical problem in the field of large-scale measured data processing.

Because of existences of the outliers and the speckles, effects of conventional filtering and noise reduction methods in data processing field may be slightly or even seriously distorted due to an influence of the outliers/speckles. A large number of theoretical studies and application examples have proved that Winner filter, Kalman filter, α−β−γ filter and common optimal frequency-domain filters are usually derived or designed according to relevant statistical criteria under a hypothesis of a specific model, and lack an Outlier-Tolerance ability to model disturbance and the outliers/speckles. Once an environment changes or an actual situation deviates from a mathematical model or a data sequence contains the outliers, performance, accuracy, and credibility of various optimal filtering algorithms mentioned above may be significantly reduced, and even algorithm crashes may occur.

A conventional method to solve the outliers is to jackknife or to eliminate method. After identifying and diagnosing the outliers, the outliers are directly removed from a sample set, which is suitable for sample statistics based on an assumption of independent identical distribution (IID). However, for sampling data of a production process, due to non-stationary and temporal correlation of an object, not only detection and diagnosis of the outliers are more difficult than that of IID, but also the sampling time series after cutting samples may change from an equally spaced sampling series to an unequally spaced sampling series, and some data analysis and processing methods will no longer adapt, thus forming new difficulties.

### SUMMARY

A technical problem to be solved by the disclosure is to provide a method and a device for sliding window constraint outlier-tolerant filtering noise reduction of petrochemical instrument sampling data, which have an effect of sliding window constraint outlier-tolerant filtering noise reduction without identifying and eliminating outliers/speckles.

In order to achieve an above objective, the disclosure adopts a following technical scheme:

The disclosure provides a method for sliding window constraint outlier-tolerant filtering noise reduction of petrochemical instrument sampling data, including following steps:
acquiring a petrochemical instrument sampling data sequence;
obtaining a sliding window constraint function and a sliding window residual constraint function according to the petrochemical instrument sampling data sequence; and
obtaining filtering and noise reduction results of instrument sampling data according to the window constraint function and the sliding window residual constraint function.

Optionally, the sliding window constraint function is:

$${f}_{y} ( {z}_{i} ) = \{ \begin{matrix}2 {U}_{y , i} - {M}_{y , i} , & {z}_{i} > 2 {U}_{y , i} - {M}_{y , i} \\ {z}_{i} , & 2 {L}_{y , i} \leq {z}_{i} + {M}_{y , i} \leq 2 {U}_{y , i} \\ 2 {L}_{y , i} - {M}_{y , i} , & {z}_{i} < 2 {L}_{y , i} - {M}_{y , i}\end{matrix} ,$$

where M_{y,i} is a median point of the petrochemical instrument sampling data sequence in a sliding window fragment, L_{y,i} is a lower quartile of the petrochemical instrument sampling data sequence in the sliding window fragment, and U_{y,i} is an upper quartile of the petrochemical instrument sampling data sequence in the sliding window fragment.

Optionally, obtaining the sliding window residual constraint function includes:
obtaining a window constraint smoothing estimation at time tᵢ and a one-order smoothing filtering residual sequence according to the sliding window constraint function; and
obtaining the sliding window residual constraint function according to the sliding window constraint function and the one-order smoothing residual sequence.

Optionally, obtaining the filtering and noise reduction results of the instrument sampling data includes:
obtaining a window constraint residual smoothing estimation at time tᵢ according to the sliding window residual constraint function; and
obtaining the filtering and noise reduction results of chemical instrument sampling data according to the window constraint smoothing estimation at time tᵢ and the window constraint residual smoothing estimation at time tᵢ.

The disclosure also provides a device for sliding window constraint outlier-tolerant filtering noise reduction of petrochemical instrument sampling data, including:
an acquisition module used for acquiring a petrochemical instrument sampling data sequence;
a construction module used for obtaining a sliding window constraint function and a sliding window residual constraint function according to the petrochemical instrument sampling data sequence; and
a calculation module used for obtaining filtering and noise reduction results of instrument sampling data according to the sliding window constraint function and the sliding window residual constraint function.

Optionally, the sliding window constraint function is:

$${f}_{y} ( {z}_{i} ) = \{ \begin{matrix}2 {U}_{y , i} - {M}_{y , i} , & {z}_{i} > 2 {U}_{y , i} - {M}_{y , i} \\ {z}_{i} , & 2 {L}_{y , i} \leq {z}_{i} + {M}_{y , i} \leq 2 {U}_{y , i} \\ 2 {L}_{y , i} - {M}_{y , i} , & {z}_{i} < 2 {L}_{y , i} - {M}_{y , i}\end{matrix} ,$$

where M_{y,i} is a median point of the petrochemical instrument sampling data sequence in a sliding window fragment, L_{y,i} is a lower quartile of the petrochemical instrument sampling data sequence in the sliding window fragment, and U_{y,i} is an upper quartile of the petrochemical instrument sampling data sequence in the sliding window fragment.

Optionally, the construction module includes:
a first calculation unit used for obtaining a window constraint smoothing estimation at time tᵢ and a one-order smoothing filtering residual sequence according to the sliding window constraint function; and
a second calculation unit used for obtaining a sliding window residual constraint function according to the sliding window constraint function and the one-order smoothing filtering residual sequence.

Optionally, the calculation module includes:
a third calculation unit used for obtaining a window constraint residual smoothing estimation at time tᵢ according to the sliding window residual constraint function; and
a fourth calculation unit used for obtaining filtering and noise reduction results of chemical instrument sampling data according to the window constraint smoothing estimation at time tᵢ and the window constraint residual smoothing estimation at time t_{i.}

The disclosure provides a sliding window constraint outlier-tolerant filtering noise reduction method without identifying and eliminating outliers/speckles, taking actual requirements of filtering and information acquisition of sampling data in petrochemical industry as an object. The disclosure has certain universality and an excellent outlier-tolerance ability, and may be applied to equally spaced sampling data filtering and noise reduction of different types of stationary or non-stationary systems. For any kind of isolated outliers and speckles with a length not exceed ¼ of a window width contained in the sampling data sequence, the method according to the disclosure may effectively avoid an adverse influence caused by the outliers/speckles, and ensure reliability of a filtering process and fidelity of filtering results.

### BRIEF DESCRIPTION OF THE DRAWINGS

FIG. 1 is a flowchart of a method for sliding window constraint outlier-tolerant filtering noise reduction of petrochemical instrument sampling data in an embodiment of the disclosure.

FIG. 2A is a scatter plot of original sampling data without error codes.

FIG. 2B is a scatter plot of moving average filtering noise reduction results for data shown in FIG. 2A.

FIG. 2C is a scatter plot of filtering noise reduction results by a method according to the disclosure for data shown in FIG. 2A.

FIG. 3A is a scatter plot of original sampling data with multiple error codes.

FIG. 3B is a scatter plot of moving average filtering noise reduction results for data shown in FIG. 3A.

FIG. 3C is a scatter plot of filtering noise reduction results by a method according to the disclosure for data shown in FIG. 3A.

### DETAILED DESCRIPTION OF THE EMBODIMENTS

In the following, technical schemes in embodiments of the disclosure may be clearly and completely described with reference to attached drawings. Obviously, the described embodiments are only a part of the embodiments of the disclosure, but not all embodiments. Based on the embodiments in the disclosure, all other embodiments obtained by ordinary technicians in the field without a creative labor belong to a scope of protection of the disclosure.

In order to make above objects, features and advantages of the disclosure more obvious and easier to understand, the disclosure may be further described in detail with the attached drawings and specific embodiments.

### Embodiment 1

The embodiment of the disclosure provides a method for sliding window constraint outlier-tolerant filtering noise reduction of petrochemical instrument sampling data, including following steps:
acquiring a petrochemical instrument sampling data sequence;
obtaining a sliding window constraint function and a sliding window residual constraint function according to the petrochemical instrument sampling data sequence; and
obtaining filtering and noise reduction results of instrument sampling data according to the window constraint function and the sliding window residual constraint function.

As an implementation of the embodiment of the disclosure, a sliding window W with a window width of wh is constructed for an equally spaced sampling data sequence S={y(tᵢ)|tᵢ=t₀+ih, i=1, . . . , N} collected by the petrochemical instrument, that is, there are only w sampling points at most in the window W. In order to facilitate data processing, a window width parameter w is usually taken as an odd number w=2k+1, and k is called an adjustable window radius (default value k=7), where y(tᵢ) is instrument sampling data at time tᵢ, tᵢ is an i-th sampling time, t₀ is an instrument sampling start time, h is a sampling time interval, and N is a number of sampling data points.

When a middle position of the window W is tᵢ, a sample passing through the window W just contains w=2k+1 sample points, forming a sampling data sequence fragment Sᵢ={y(tⱼ)|tⱼ=tᵢ+(j−i)h, j=i−k, . . . , i+k}⊂S. Sampling data of this fragment is sorted in size to obtain a fragment {ŷⱼ|j=i−k, . . . , i+k} sorted from small to large, and three feature points are extracted, namely:
a median is M_{y,i}=ŷᵢ, a lower quartile is L_{y,i}=ŷ_{i-[k/2]} and an upper quartile is

$${U}_{y , i} = {\hat{y}}_{i + [ k / 2 ]} , \qquad ( 1 )$$

where y(tⱼ) is instrument sampling data at time tⱼ, tⱼ is a j-th sampling time, ŷⱼ is a j-th value of 2k+1 sample data sorted from small to large in the sampling data sequence fragment Sᵢ, and ŷ_{i-[k/2]} and ŷ_{i+[k/2]} are lower quartile data and the upper quartile data of the 2k+1 sample data sorted from small to large in the sampling data sequence fragment Sᵢ, respectively.

In order to avoid a loss of information caused by shortening of a subsequent processing sequence, left and right ends of the sampling data sequence S are extended in an equivalent supplementary way:

$$\tilde{S} = \{ y ( {t}_{i} ) = y ( {t}_{1} ) \vert i = - k + 1 , … , 0 \} ⋃ S ⋃ \{ y ( {t}_{i} ) = y ( {t}_{N} ) \vert i = N + 1 , … , N + k - 1 \} . \qquad ( 2 )$$

For an extended sample sequence \tilde{S}, the window W gradually slides from left to right, and a median sequence {M_{y,i}|i=1, . . . , N}, a lower quartile sequence {L_{y,i}|i=1, . . . , N} and an upper quartile sequence {U_{y,i}|i=1, . . . , N} generated by S are obtained.

For the petrochemical instrument sampling data sequence, the sliding window constraint function is constructed based on the three feature points, such as the median, the lower quartile and the upper quartile in a formula (1):

$${f}_{y} ( {z}_{i} ) = \{ \begin{matrix}2 {U}_{y , i} - {M}_{y , i} , & {z}_{i} > 2 {U}_{y , i} - {M}_{y , i} \\ {z}_{i} , & 2 {L}_{y , i} \leq {z}_{i} + {M}_{y , i} \leq 2 {U}_{y , i} \\ 2 {L}_{y , i} - {M}_{y , i} , & {z}_{i} < 2 {L}_{y , i} - {M}_{y , i}\end{matrix} . \qquad ( 3 )$$

As an implementation of the embodiment of the disclosure, obtaining the sliding window residual constraint function includes:
obtaining a window constraint smoothing estimation at time tᵢ and a one-order smoothing filtering residual sequence according to the sliding window constraint function; and
obtaining the sliding window residual constraint function according to the sliding window constraint function and the one-order smoothing residual sequence.

In an embodiment, constraint smoothing is performed on the sample data within the window W by using a formula (3), and the window constraint smoothing estimation at time tᵢ is obtained:

$$\hat{y} ( {t}_{i} ) = \frac{1}{2 k + 1} {\sum }_{j = - k}^{k} {f}_{y} ( y ( {t}_{i + j} ) ) ( i = 1 , … , N ) , \qquad ( 4 )$$

where, y(tᵢ₊ⱼ) is instrument sampling data at time tᵢ₊ⱼ, and f(y(tᵢ₊ⱼ)) is a function value of the sample data defined by the formula (3).

And in a one-order smoothing filtering residual sequence E={ε(tᵢ)=y(tᵢ)−ŷ(tᵢ)|i=1, . . . , N}, ŷ(tᵢ) is a constrained mean filtering estimate calculated according to a formula (4).

In order to avoid a loss of information caused by sequence shortening, left and right ends of the smoothing filtering residual sequence E are extended in a zero value supplementary way:

$$\tilde{E} = \{ ε ( {t}_{i} ) = 0 \vert i = - k + 1 , … , 0 \} ⋃ E ⋃ \{ ε ( {t}_{i} ) = 0 \vert i = N + 1 , … , N + k - 1 \} . \qquad ( 5 )$$

For an extended residual sequence \tilde{E}, the window W gradually slides from left to right to obtain a median sequence {M_{ε,i}|i=1, . . . , N}, a lower quartile sequence {L_{ε,i}|i=1, . . . , N}, and an upper quartile sequence {U_{ε,i}|i=1, . . . , N} generated by \tilde{E}, and the sliding window residual constraint function is constructed:

$${f}_{ε} ( {z}_{i} ) = \{ \begin{matrix}2 {U}_{ε , i} - {M}_{ε , i} , & {z}_{i} > 2 {U}_{ε , i} - {M}_{ε , i} \\ {z}_{i} , & 2 {L}_{ε , i} \leq {z}_{i} + {M}_{ε , i} \leq 2 {U}_{ε , i} \\ 2 {L}_{ε , i} - {M}_{ε , i} , & {z}_{i} < 2 {L}_{ε , i} - {M}_{ε , i}\end{matrix} . \qquad ( 6 )$$

As an implementation of the embodiment of the disclosure, obtaining the filtering and noise reduction results of the instrument sampling data includes:
obtaining a window constraint residual smoothing estimation at time tᵢ according to the sliding window residual constraint function; and
obtaining the filtering and noise reduction results of chemical instrument sampling data S={y(tᵢ)|tᵢ=t₀+ih, i=1, . . . , N} according to the window constraint smoothing estimation at time tᵢ and the window constraint residual smoothing estimation at time tᵢ.

In an embodiment, a residual in the window W is constrained and smoothed by a formula (6), and the window constraint residual smoothing estimation at time tᵢ is obtained:

$$\tilde{ε} ( {t}_{i} ) = \frac{1}{2 k + 1} {\sum }_{{j = - k}^{}}^{k} {f}_{ε} ( ε ( {t}_{i + j} ) ) ( i = 1 , … , N ) , \qquad ( 7 )$$

where ε(tᵢ)=y(tᵢ)−ŷ(tᵢ), and f_{ε}(ε(tᵢ₊ⱼ)) is a function value of the function defined by the formula (6).

A residual smoothing estimation {\hat{ε}(tᵢ)|i=1, . . . , N} is used to compensate a first smoothing filter sequence {ŷ(tᵢ)|i=1, . . . , N} by a superposition method:

$$\tilde{y} ( {t}_{i} ) = \hat{y} ( {t}_{i} ) + \hat{ε} ( {t}_{i} ) ( i = 1 , … , N ) . \qquad ( 8 )$$

The filtering and noise reduction results of the chemical instrument sampling data S={y(tᵢ)|tᵢ=t₀+ih, i=1, . . . , N} are obtained.

According to the sliding window constraint outlier-tolerant filtering method of the embodiment of the disclosure, measured data of the instrument are filtered and denoised, and an influence of various isolated outliers may be effectively avoided without special identification and elimination of outliers. For local scattered abnormal data speckles, as long as a length of each of the speckles is less than half of a window radius (that is k/2), it may also ensure that the filtering and noise reduction results are not affected by the speckles.

### Embodiment 2

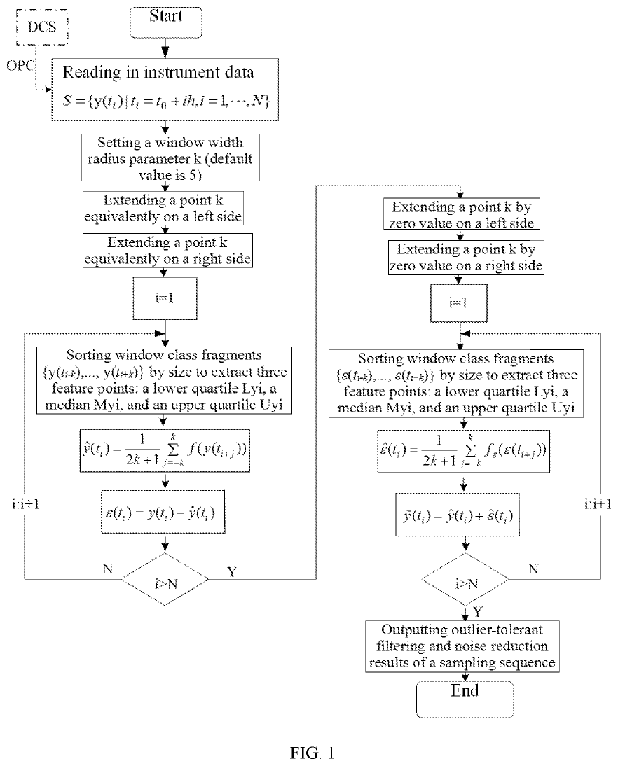

In a process of petrochemical production, instrument data is usually read from a Distributed Control System (DCS) by Object Linking and Embedding for Process Control (OPC). Therefore, an implementation process of the method for sliding window constraint outlier-tolerant filtering noise reduction of petrochemical instrument sampling data described in the patent of this disclosure includes following steps, as shown in FIG. 1:
S1: adopting the instrument sampling data sequence S={y(tᵢ)|tᵢ=t₀+ih, i=1, . . . , N} read from the DCS using the OPC;
S2: setting a window width adjustable parameter k (default value 5) and a window width parameter w=2k+1;
S3: extending the left and right ends of the sampling data sequence S in an equivalent supplementary way according to the formula (1):

$$\tilde{S} = \{ y ( {t}_{i} ) = y ( {t}_{1} ) \vert i = - k + 1 , … , 0 \} ⋃ S ⋃ \{ y ( {t}_{i} ) = y ( {t}_{N} ) \vert i = N + 1 , … , N + k - 1 \} ;$$

S4: when a midpoint in the window W is tᵢ, sorting the sampling data of the fragment {y(tⱼ)|tⱼ=tᵢ+(j−i)h, j=i−k, . . . , i+k}⊂\tilde{S} in size to get fragments {ŷⱼ|j=i−k, . . . , i+k} sorted from small to large;
S5: extracting the median M_{y,i}=ŷᵢ, the lower quartile L_{y,i}=ŷ_{i-[k/2]} and the upper quartile U_{y,i}=ŷ_{i+[k/2]};
S6: sliding the window to right for a sampling interval, and repeating S4-S5 until the window W slides to a far right of \tilde{S};
S7: forming the median sequence {M_{ε,i}|i=1, . . . , N}, the lower quartile sequence {L_{ε,i}|i=1, . . . , N}, and the upper quartile sequence {U_{ε,i}|i=1, . . . N};
S8, using the sliding window constraint function (3) to obtain window constraint smoothing estimations ŷ(tᵢ) at all times tᵢ and the one-order smoothing filtering residual sequence E:

$$\hat{y} ( {t}_{i} ) = \frac{1}{2 k + 1} {\sum }_{j = - k}^{k} {f}_{y} ( y ( {t}_{i + j} ) ) ( i = 1 , … , N )$$

$$ε = \{ ε ( {t}_{i} ) = y ( {t}_{i} ) - \hat{y} ( {t}_{i} ) \vert i = 1 , … , N \} ;$$

S9: extending the left and right ends of the smoothing filtering residual sequence E in a zero value supplementary way according to the formula (5):

$$\tilde{E} = \{ ε ( {t}_{i} ) = 0 \vert i = - k + 1 , … , 0 \} ⋃ E ⋃ \{ ε ( {t}_{i} ) = 0 \vert i = N + 1 , … , N + k - 1 \} ;$$

S10: for the extended residual sequence \tilde{E}, gradually sliding the window W from left to right to obtain the median sequence {M_{ε,i}|i=1, . . . , N}, the lower quartile sequence {L_{ε,i}|i=1, . . . , N}, and the upper quartile sequence {U_{ε,i}|i=1, . . . , N} generated by \tilde{E};
S11: using the sliding window residual constraint function (6) to constrain and smooth the residual in the window W to obtain the window constraint residual smoothing estimation at time tᵢ:

$$\hat{ε} ( {t}_{i} ) = \frac{1}{2 k + 1} {\sum }_{j = - k}^{k} {f}_{ε} ( ε ( {t}_{i + j} ) ) ( i = 1 , … , N ) ;$$

and
S12: compensating a one-order smoothing filter sequence {ŷ(tᵢ)|i=1, . . . , N} by superposition by using the residual smoothing estimation {\hat{ε}(tᵢ)|i=1, . . . , N} according to the formula (8):

$$\tilde{y} ( {t}_{i} ) = \hat{y} ( {t}_{i} ) + \hat{ε} ( {t}_{i} ) ( i = 1 , … , N ) ,$$

and
obtaining the filtering and noise reduction results of the chemical instrument sampling data S={y(tᵢ)|tᵢ=t₀+ih, i=1, . . . , N}.

### Application Example

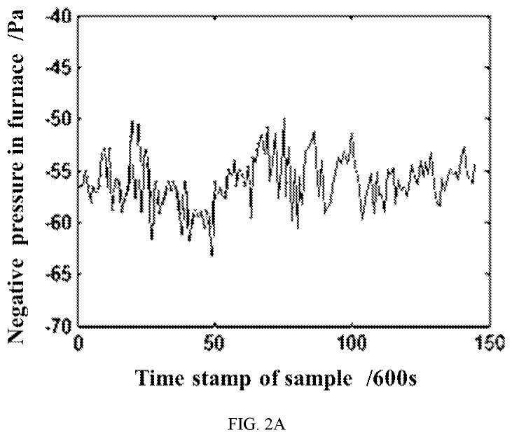

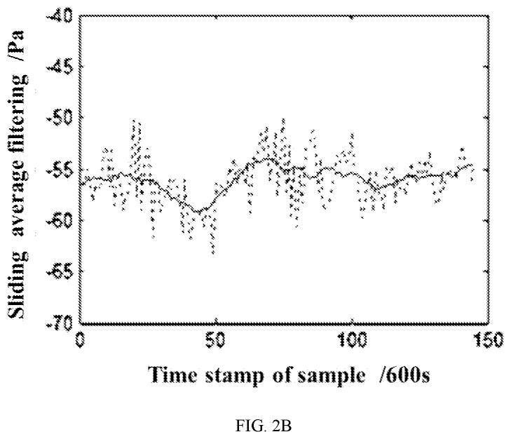

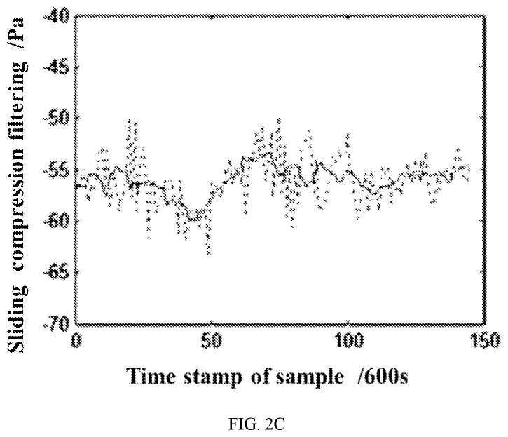

FIG. 2A shows measured data of furnace negative pressure (unit: Pa) of a coking heating furnace, with total data points N=145 and a sampling interval of 600 seconds. A sliding window parameter s=15 (k=7) is set, and the filtering method according to the disclosure (results are as shown in FIG. 2C) and a classical sliding polynomial filtering method (as shown in FIG. 2B) widely used in engineering field are used respectively for filtering. Comparing FIG. 2B with FIG. 2C, it may be clearly seen that when sampling is error code-free and data is normal, effects of two kinds of filtering noise reduction are equivalent: a residual root variance of sliding polynomial filtering noise reduction is 1.9466 pa, and a residual root variance of filtering noise reduction by the filtering method according to the disclosure is 2.1939 pa, which are statistically similar.

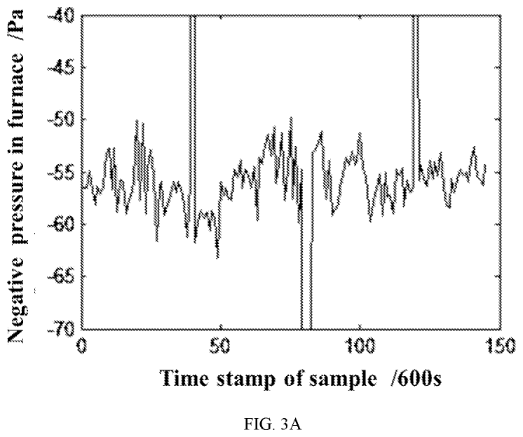

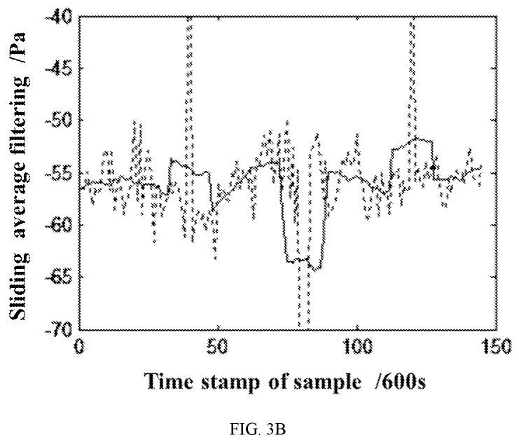

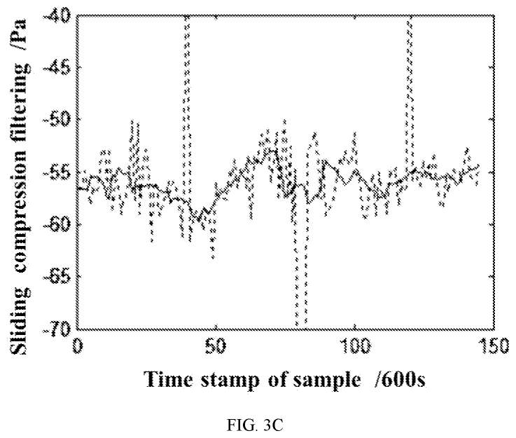

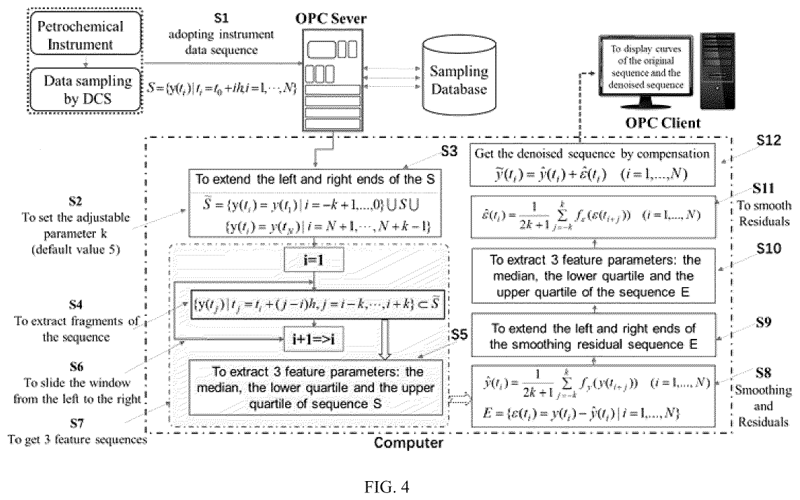

FIG. 3A shows sample data with outliers/speckles with two isolated error codes and one continuous error code formed by biasing data (a 40th sampling point is biased to 0 pa, 80th, 81st and 82nd sampling points are biased to −100 pa, and a 120th sampling point is biased to 0 pa) in FIG. 2A. Aforementioned settings are adopted: a sliding window parameter is set as s=15 (k=7), and the filtering method according to the disclosure (result are as shown in FIG. 3C) and a classical sliding polynomial filtering method (as shown in FIG. 3B) widely used in engineering field are used respectively for filtering. Comparing FIG. 3B with FIG. 3C, it may be clearly seen that when sampling data contains error codes or abnormal data, there are significant differences in effects of two kinds of filtering noise reduction: a residual root variance of sliding polynomial filtering noise reduction is 2.9676 pa, and a residual root variance of the filtering noise reduction method according to the disclosure is 1.9537 pa. Moreover, it may be clearly seen from FIG. 3B that a filtering noise reduction curve is obviously deformed near outliers and speckles. It may be clearly seen from FIG. 3C that the filtering noise reduction curve obtained by this method is almost unaffected by the outliers and the speckles, thus maintaining high-fidelity extraction of signals.

### Embodiment 3

The disclosure also provides a device for sliding window constraint outlier-tolerant filtering noise reduction of petrochemical instrument sampling data, including:
an acquisition module used for acquiring a petrochemical instrument sampling data sequence;
a construction module used for obtaining a sliding window constraint function and a sliding window residual constraint function according to the petrochemical instrument sampling data sequence; and
a calculation module used for obtaining filtering and noise reduction results of instrument sampling data according to the window constraint function and the sliding window residual constraint function.

As an implementation of the embodiment of the disclosure, the sliding window constraint function is:

$${f}_{y} ( {z}_{i} ) = \{ \begin{matrix}2 {U}_{y , i} - {M}_{y , i} , & {z}_{i} > 2 {U}_{y , i} - {M}_{y , i} \\ {z}_{i} , & 2 {L}_{y , i} \leq {z}_{i} + {M}_{y , i} \leq 2 {U}_{y , i} \\ 2 {L}_{y , i} - {M}_{y , i} , & {z}_{i} < 2 {L}_{y , i} - {M}_{y , i}\end{matrix} .$$

As an implementation of the embodiment of the disclosure, the construction module includes:
a first calculation unit used for obtaining a window constraint smoothing estimation at time tᵢ and a one-order smoothing filtering residual sequence according to the sliding window constraint function; and
a second calculation unit used for obtaining a sliding window residual constraint function according to the sliding window constraint function and the one-order smoothing filtering residual sequence.

As an implementation of the embodiment of the disclosure, the calculation module includes:
a third calculation unit used for obtaining a window constraint residual smoothing estimation at time tᵢ according to the sliding window residual constraint function; and
a fourth calculation unit used for obtaining filtering and noise reduction results of chemical instrument sampling data according to the window constraint smoothing estimation at time tᵢ and the window constraint residual smoothing estimation at time tᵢ.

The above is only specific embodiments of the disclosure, but a protection scope of the disclosure is not limited to this. Any change or substitution that may be easily thought of by any person familiar with the technical field within a technical scope of the disclosure should be covered by the protection scope of the disclosure, so the protection scope of the disclosure should be subject to the protection scope of claims.

1. A method for sliding window constraint outlier-tolerant filtering noise reduction of petrochemical instrument sampling data, comprising following steps:
acquiring a petrochemical instrument sampling data sequence read from a Distributed Control System (DCS) using an Object Linking and Embedding for Process Control (OPC);
obtaining a sliding window constraint function and a sliding window residual constraint function according to the petrochemical instrument sampling data sequence; and
obtaining filtering and noise reduction results of instrument sampling data according to the sliding window constraint function and the sliding window residual constraint function, wherein
the sliding window constraint function is:
$${f}_{y} ( {z}_{i} ) = \{ \begin{matrix}2 {U}_{y , i} - {M}_{y , i} , & {z}_{i} > 2 {U}_{y , i} - {M}_{y , i} \\ {z}_{i} , & 2 {L}_{y , i} \leq {z}_{i} + {M}_{y , i} \leq 2 {U}_{y , i} \\ 2 {L}_{y , i} - {M}_{y , i} , & {z}_{i} < 2 {L}_{y , i} - {M}_{y , i}\end{matrix} ,$$
wherein M_{y,i} is a median point of the petrochemical instrument sampling data sequence in a sliding window fragment, L_{y,i} is a lower quartile of the petrochemical instrument sampling data sequence in the sliding window fragment, and U_{y,i} is an upper quartile of the petrochemical instrument sampling data sequence in the sliding window fragment, Zi represents the instrument sampling data at the i-th sampling time;
obtaining the sliding window residual constraint function comprises:
obtaining a window constraint smoothing estimation at time tᵢ and a one-order smoothing filtering residual sequence according to the sliding window constraint function; and
obtaining the sliding window residual constraint function according to the sliding window constraint function and the one-order smoothing residual sequence.

2. The method for sliding window constraint outlier-tolerant filtering noise reduction of petrochemical instrument sampling data according to claim 1, wherein obtaining the filtering and noise reduction results of the instrument sampling data comprises:
obtaining a window constraint residual smoothing estimation at time tᵢ according to the sliding window residual constraint function; and
obtaining the filtering and noise reduction results of the instrument sampling data according to the window constraint smoothing estimation at time tᵢ and the window constraint residual smoothing estimation at time tᵢ.

3.-4. (canceled)
